(19) United States
(12) Patent Application Publication
(10) Pub. No.: US 2024/0359100 A1
(43) Pub. Date: Oct. 31, 2024

(54) Upgrade Interaction Method and Apparatus for Game Task, Medium, Device, and Program Product

(71) Applicant: Tencent Technology (Shenzhen) Company Limited, Shenzhen (CN)

(72) Inventor: Ye Kuang, Shenzhen (CN)

(21) Appl. No.: 18/766,775

(22) Filed: Jul. 9, 2024

Related U.S. Application Data
(63) Continuation of application No. PCT/CN2023/088264, filed on Apr. 14, 2023.

(30) Foreign Application Priority Data
Jun. 1, 2022 (CN) 2022106185006

(51) Int. Cl. A63F 13/55; A63F 13/537

(52) U.S. Cl. CPC A63F 13/55; A63F 13/537

(57) ABSTRACT

The present disclosure describes user interfaces for a human-computer interaction in dynamic immersive environments such as video games. Methods may include, while displaying a task picture of a virtual game task in which a controlled virtual character currently participates, providing a resource exchange control that allows a user to upgrade a game resource by consuming a material resource owned by a controlled virtual character. When the user activates the resource exchange control, the system determines an upgrade acceleration speed based on the user input and the amount of the material resource owned by the character. The system then upgrades the controlled virtual character from a first level to a second level when the determined upgrade speed is an accelerated speed. The system may then play back an upgrade animation accordingly. The present disclosure resolves a problem of poor flexibility of an existing upgrade interaction method.

### CROSS REFERENCE TO RELATED APPLICATIONS

This application is a continuation application of PCT application PCT/CN2023/088264, filed Apr. 14, 2023, which claims priority to Chinese Patent Application No. 202210618500.6, filed with the China National Intellectual Property Administration on Jun. 1, 2022, each entitled “UPGRADE INTERACTION METHOD AND APPARATUS FOR GAME TASK, STORAGE MEDIUM, AND ELECTRONIC DEVICE”, and each of which is incorporated by reference in its entirety.

### FIELD

The present disclosure relates to the field of computers, and in particular, to upgrade interaction of a game task.

### BACKGROUND

In an existing tactical strategy game application, at a preparation stage, a player can use, based on a specific strategy, virtual gold coins to upgrade a level in a game, and can also use the virtual gold coins to purchase and upgrade a virtual figure. At a battle stage, virtual figures respectively controlled by two players automatically fight to determine a result of a game.

Generally, an opportunity for the player to operate the virtual figure at the preparation stage is related to a current level of the player in the game. For example, a higher level of the player in the game indicates that more virtual figures are allowed to participate in a battle in a control field of the player. In other words, in the game, choosing to use the virtual gold coins to improve the level in the game or purchase the virtual figure has become an important game strategy.

An existing method of upgrading the level of the player in the game is generally to exchange a fixed quantity of virtual gold coins for a fixed quantity of experience points in the game. The player increases the experience points in the game a plurality of times by a plurality of exchange operations. In a case that the experience points in the game reach a preset threshold, upgrade of the level in the game is completed. In the existing method of using the fixed virtual gold coins to exchange for the fixed quantity of experience points, the player needs to perform a plurality of tap/click operations. This is cumbersome. In other words, an existing upgrade interaction method in a game task has a technical problem of poor flexibility.

For the foregoing problem, no effective solution has been provided yet.

### SUMMARY

Aspects of the present disclosure provide an upgrade interaction method and apparatus for a game task, a medium, an electronic device, and a program product, to at least resolve a technical problem of poor flexibility in an existing upgrade interaction method.

According to an aspect of the present disclosure, an upgrade interaction method for a game task is provided, including: displaying a task picture of a virtual game task of a controlled virtual character, the virtual game task being a multi-round confrontation task between a plurality of virtual characters, and each round of the multi-round confrontation task being a process in which two virtual characters each select at least one virtual figure to participate in a confrontation; displaying a resource exchange control in the task picture, the resource exchange control being configured to obtain an upgrade resource by using a material resource owned by the controlled virtual character; determining, in response to a control operation on the resource exchange control, an upgrade interaction state that matches an operation parameter of the control operation; and upgrading the controlled virtual character from a first level to a second level in a case that the upgrade interaction state indicates that an upgrade acceleration condition is satisfied, and playing back a corresponding upgrade animation, a quantity of virtual figures allowed to participate in a confrontation at the first level being less than a quantity of virtual figures allowed to participate in a confrontation at the second level.

According to another aspect of the present disclosure, an upgrade interaction apparatus for a game task is further provided, including: a first display unit, configured to display a task picture of a virtual game task of a controlled virtual character, the virtual game task being a multi-round confrontation task between a plurality of virtual characters, and each round of the multi-round confrontation task being a process in which two virtual characters each select at least one virtual figure to participant in a confrontation; a second display unit, configured to display a resource exchange control in the task picture, the resource exchange control being configured to obtain an upgrade resource by using a material resource owned by the controlled virtual character; a determining unit, configured to determine, in response to a control operation on the resource exchange control, an upgrade interaction state that matches an operation parameter of the control operation; and a playback unit, configured to upgrade the controlled virtual character from a first level to a second level in a case that the upgrade interaction state indicates that an upgrade acceleration condition is satisfied, and play back a corresponding upgrade animation, a quantity of virtual figures allowed to participate in a confrontation at the first level being less than a quantity of virtual figures allowed to participate in a confrontation at the second level.

According to still another aspect of the present disclosure, a computer-readable storage medium is further provided, having a computer program stored thereon, the computer program, when run, performing the foregoing upgrade interaction method for a game task.

According to still another aspect of this application, a computer program product is provided. The computer program product includes a computer program, and the computer program is stored in a computer-readable storage medium. A processor of a computer device reads the computer program from the computer-readable storage medium. The processor executes the computer program to cause the computer device to perform the foregoing upgrade interaction method for a game task.

According to still another aspect of of the present disclosure, an electronic device is further provided, including a memory and a processor, the memory having a computer program stored therein, and the processor being configured to perform the foregoing upgrade interaction method for a game task by using the computer program.

In aspects of the present disclosure, a task picture of a virtual game task of a controlled virtual character is displayed. The virtual game task is a multi-round confrontation task between a plurality of virtual characters. Each round of the multi-round confrontation task is a process in which two virtual characters each select at least one virtual figure to participate in a confrontation. A resource exchange control is displayed in the task picture. The resource exchange control is configured to obtain an upgrade resource by using a material resource owned by the controlled virtual character. An upgrade interaction state that matches an operation parameter of a control operation is determined in response to the control operation on the resource exchange control. The controlled virtual character is upgraded from a first level to a second level in a case that the upgrade interaction state indicates that an upgrade acceleration condition is satisfied, and a corresponding upgrade animation is played back. A quantity of virtual figures allowed to participate in a confrontation at the first level is less than a quantity of virtual figures allowed to participate in a confrontation at the second level. In this way, the upgrade interaction state corresponding to the control operation on the resource exchange control is detected to determine whether an upgrade interaction operation is completed based on a current operation, thereby avoiding a plurality of repeated operations, resolving a technical problem of poor flexibility in an existing upgrade interaction method, and achieving a technical effect of flexible upgrade based on a touch/press operation parameter.

### BRIEF DESCRIPTION OF THE DRAWINGS

FIG. 1 is a schematic diagram of an application environment of an optional upgrade interaction method for a game task according to an illustrative aspect of the present disclosure.

FIG. 2 is a schematic flowchart of an optional upgrade interaction method for a game task according to an illustrative aspect of the present disclosure.

FIG. 3 is a schematic diagram of an optional upgrade interaction method for a game task according to an illustrative aspect of the present disclosure.

FIG. 4 is a schematic diagram of another optional upgrade interaction method for a game task according to an illustrative aspect of the present disclosure.

FIG. 5 is a schematic diagram of still another optional upgrade interaction method for a game task according to an illustrative aspect of the present disclosure.

FIG. 6 is a schematic diagram of still another optional upgrade interaction method for a game task according to an illustrative aspect of the present disclosure.

FIG. 7 is a schematic diagram of still another optional upgrade interaction method for a game task according to an illustrative aspect of the present disclosure.

FIG. 8 is a schematic diagram of still another optional upgrade interaction method for a game task according to an illustrative aspect of the present disclosure.

FIG. 9 is a schematic diagram of still another optional upgrade interaction method for a game task according to an illustrative aspect of the present disclosure.

FIG. 10 is a flowchart of another optional upgrade interaction method for a game task according to an illustrative aspect of the present disclosure.

FIG. 11 is a sequence diagram of an optional upgrade interaction method for a game task according to an illustrative aspect of the present disclosure.

FIG. 12 is a flowchart of still another optional upgrade interaction method for a game task according to an illustrative aspect of the present disclosure.

FIG. 13 is a sequence diagram of another optional upgrade interaction method for a game task according to an illustrative aspect of the present disclosure.

FIG. 14 is a schematic diagram of a structure of an optional upgrade interaction apparatus for a game task according to an illustrative aspect of the present disclosure.

FIG. 15 is a schematic diagram of a structure of an optional electronic device according to an illustrative aspect of the present disclosure.

### DETAILED DESCRIPTION

To make a person skilled in the art understand the solutions in the present disclosure better, the following describes the technical solutions in aspects of the present disclosure with reference to the accompanying drawings in aspects of the present disclosure. The described aspects are merely some but not all of aspects of the present disclosure. All other aspects obtained by a person of ordinary skill in the art based on aspects of the present disclosure shall fall within the protection scope of the present disclosure.

In the specification, claims, and the foregoing accompanying drawings of the present disclosure, the terms “first”, “second”, and the like are intended to distinguish between similar objects rather than indicating a specific order. Data used in this way is exchangeable in a proper case, so that aspects of the present disclosure described herein can be implemented in an order different from the order shown or described herein. Moreover, the terms “include”, “have”, and any other variants are intended to cover the non-exclusive inclusion, for example, a process, method, system, product, or device that includes a list of operations or units is not necessarily limited to those expressly listed operations or units, but may include other operations or units not expressly listed or inherent to such a process, method, system, product, or device.

Aspects of this application include the following technical terms.

Auto chess: It is a multi-player turn-based competitive game with trading champion cards in a game. There are eight players in the game, each occupying a chessboard. Each round includes two stages, that is, preparation and fight. At the preparation stage, the player purchases chess pieces (champions) and arranges the chess pieces on the chessboard. At the fight stage, lineups of both sides are locked, and the chess pieces automatically engage in a battle until all chess pieces on one side are killed. A player whose chess pieces are all killed is the loser of this round, and a specific quantity of health points is deducted. Game rounds are repeated continuously and new opponents are matched until the player is knocked out when health points of the player are less than or equal to 0. A last remaining player wins the game (first place).

Gold coin: It is a basic resource for purchasing a champion, upgrading a champion, and refreshing a store during a game. In each round, a fixed additional reward of 10% of a current quantity of gold coins is received. Continuous wins or defeats also result in additional gold coin rewards.

Upgrade: Indicates a game mechanism herein of purchasing experience by consuming gold coins in an auto chess game, and accumulating sufficient experience to upgrade a current team level, to increase a quantity of champions in a battle.

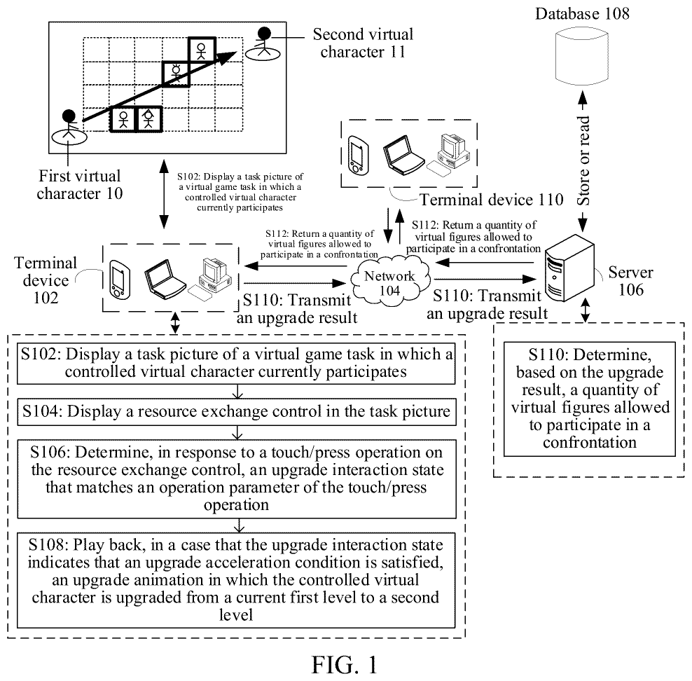

According to an aspect of the present disclosure, an upgrade interaction method for a game task is provided. As an optional implementation, the foregoing upgrade interaction method for a game task may be, but is not limited to, applied to an upgrade interaction system for a game task in a hardware environment as shown in FIG. 1. The upgrade interaction system for a game task may include, but is not limited to, a terminal device 102, a network 104, a server 106, a database 108, and a terminal device 110. Both the terminal device 102 and the terminal device 110 run a client of a battle game application. The terminal device 102 includes a human-machine interaction screen, a processor, and a memory. A virtual scene provided by a battle game task is displayed on the human-machine interaction screen. The virtual scene includes a first virtual character 10 and a second virtual character 11 that participate in the battle game task and belong to different camps. The first virtual character 10 and the second virtual character 11 here may directly confront each other in the virtual scene, and may alternatively control virtual figures respectively owned by the first virtual character 10 and the second virtual character 11 to confront. The human-machine interaction screen is further configured to provide a human-machine interaction interface to receive a human-machine interaction operation for controlling a controlled virtual figure in the virtual scene, and the virtual figure completes the battle game task set in the virtual scene. The processor is configured to generate an interaction instruction in response to the human-machine interaction operation, and transmit the interaction instruction to the server. The memory is configured to store related attribute data, for example, picture data of a scene picture, attribute information of a virtual figure controlled by the client (for example, level information of the virtual figure, health points of the virtual figure, and a quantity or types of virtual characters owned by the virtual figure), and a virtual social resource owned by the virtual figure controlled by the client.

In addition, the server 106 includes a processing engine configured to perform a storage operation or a read operation on the database 108. Specifically, the processing engine determines an upgrade operation result based on a touch/press operation instruction on a resource exchange control fed back by the terminal device 110. In a case that it is determined that upgrade is completed, the processing engine upgrades a virtual character from a first level to a second level, and increases a quantity of virtual figures allowed to participate in a confrontation on a current field of the virtual character. In addition, upgrade animations corresponding to different levels are read from the database 108, and the corresponding upgrade animations are displayed in a game interface.

An illustrative process is as follows. Operation S102: Display, in the terminal device 102, a task picture of a virtual game task in which a controlled virtual character currently participates, the virtual game task being a multi-round confrontation task between a plurality of virtual characters, and each round of the multi-round confrontation task being a process in which two virtual characters each select at least one virtual figure to participant in a confrontation. Operation S104: Display a resource exchange control in the task picture, the resource exchange control being configured to obtain an upgrade resource by using a material resource owned by the controlled virtual character. Operation S106: Determine, in response to a touch/press operation on the resource exchange control, an upgrade interaction state that matches an operation parameter of the touch/press operation. Operation S108: Play back, in a case that the upgrade interaction state indicates that an upgrade acceleration condition is satisfied, an upgrade animation in which the controlled virtual character is upgraded from a current first level to a second level, a quantity of virtual figures allowed to participate in a confrontation at the first level being less than a quantity of virtual figures allowed to participate in a confrontation at the second level. Operation S110: The terminal device 102 transmits an upgrade result to the server 106 over the network 104.

The server 106 performs operation S110 and operation S112 to determine, based on the upgrade result, the quantity of virtual figures allowed to participate in a confrontation, and return the quantity of virtual figures allowed to participate in a confrontation to the terminal device 102 over the network 104.

As another optional implementation, when the terminal device 102 has a powerful computing processing capability, the operation S110 may alternatively be performed by the terminal device 102. This is an example, which is not limited in this aspect.

In aspects of the present disclosure, a task picture of a virtual game task in which a controlled virtual character currently participates is displayed, the virtual game task being a multi-round confrontation task between a plurality of virtual characters, and each round of the multi-round confrontation task being a process in which two virtual characters each select at least one virtual figure to participant in a confrontation; a resource exchange control is displayed in the task picture, the resource exchange control being configured to obtain an upgrade resource by using a material resource owned by the controlled virtual character; an upgrade interaction state that matches an operation parameter of a control operation is determined in response to the control operation on the resource exchange control; and the controlled virtual character is upgraded from a first level to a second level in a case that the upgrade interaction state indicates that an upgrade acceleration condition is satisfied, and a corresponding upgrade animation is played back, a quantity of virtual figures allowed to participate in a confrontation at the first level being less than a quantity of virtual figures allowed to participate in a confrontation at the second level. In this way, the upgrade interaction state corresponding to a touch/press operation on the resource exchange control is detected to determine whether an upgrade interaction operation is completed based on a current operation, thereby avoiding a plurality of repeated operations, resolving a technical problem of poor flexibility in an existing upgrade interaction method, and achieving a technical effect of flexible upgrade based on a touch/press operation parameter.

In this aspect, the foregoing upgrade interaction method for a game task may be, but is not limited to, applied to a user device. The user device may be, but is not limited to, a mobile phone, a tablet computer, a laptop computer, a personal computer (PC for short), and another user device that supports running an application client. The server and the user device may, but are not limited to, implement data exchange over a network. The network may include, but is not limited to, a wireless network or a wired network. The wireless network includes Bluetooth, Wi-Fi, and another network for wireless communication. The wired network includes, but is not limited to, a wide area network, a metropolitan area network, and a local area network. The foregoing is merely an example, which is not limited in this aspect.

In this aspect, the game application may be a single-player game (SPG for short) application. A type of the game application may include, but is not limited to, at least one of the following: a two-dimensional (2D for short) game application, a three-dimensional (3D for short) game application, a virtual reality (VR for short) game application, an augmented reality (AR for short) game application, or a mixed reality (MR for short) game application. The foregoing is merely an example, which is not limited in this aspect.

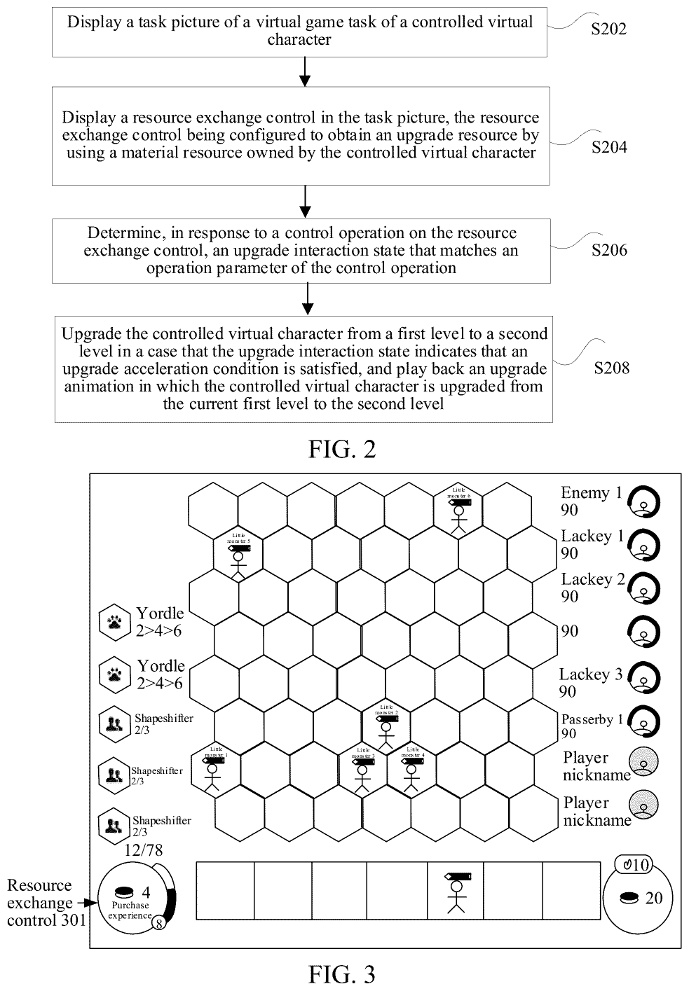

As an optional implementation, as shown in FIG. 2, the foregoing upgrade interaction method for a game task includes:

S202: Display a task picture of a virtual game task of a controlled virtual character, the virtual game task being a multi-round confrontation task between a plurality of virtual characters, and each round of the multi-round confrontation task being a process in which two virtual characters each select at least one virtual figure to participate in a confrontation.

Specifically, the virtual game task may be a multi-player turn-based competitive game with trading champion cards in a game. There are N players in the game (where N is an even number greater than 0), and the players battle in pairs in one game round. The players in the game each occupy a virtual battle field, and at a battle stage, fields of the two players who battle each other are spliced for the two players to battle each other in a spliced virtual battle field. Each game task round includes two stages, that is, preparation and fight. At the preparation stage, the player purchases chess pieces (that is, virtual figures) and arranges the chess pieces on a chessboard. At the fight stage, lineups of both sides are locked, and the chess pieces automatically engage in a battle until all chess pieces on one side are killed. A player whose chess pieces are all killed is the loser of this round, and a specific quantity of health points (battle resources) of the loser is deducted. After a round ends, game rounds are repeated continuously and each player matches a new opponent until the player is knocked out when health points of the player are less than or equal to 0. A last remaining player wins the game (first place).

An optional virtual game task picture may be shown in FIG. 3, which displays a game task picture of a currently controlled virtual character. The currently controlled virtual character is a game account entity controlled by a current game player (not shown). “Little monster 1”, “little monster 2”, “little monster 3”, and “little monster 4” shown in FIG. 3 are virtual figures selected by the currently controlled virtual character to participate in a confrontation. Correspondingly, “little monster 5” and “little monster 6” shown in FIG. 3 are virtual figures selected by an account entity (an opponent virtual character of the currently controlled virtual character) controlled by an opponent player to participate in a confrontation. In this aspect, at the preparation stage, the controlled virtual character and the opponent virtual character of the controlled virtual character can select virtual figures to participate in a battle, improve levels of the virtual figures participating in the battle, and arrange positions of the virtual figures. At the battle stage, the virtual figures in FIG. 3 are controlled to automatically battle, and in a case that all virtual figures on one side are “killed”, a result of a current round is determined.

S204: Display a resource exchange control in the task picture, the resource exchange control being configured to obtain an upgrade resource by using a material resource owned by the controlled virtual character.

First, the material resource is described. The material resource may be a material resource, such as a virtual gold coin, a virtual treasure, or a virtual exchange resource, owned by the controlled virtual character for operating transaction. The upgrade resource may be a virtual experience point for indicating a game operation level or game duration of the currently controlled virtual character. A game level of the currently controlled virtual character can be improved by accumulating virtual experience points.

As an optional manner, the controlled virtual character may obtain upgrade resources with different values based on a result of a battle participating in. For example, in a case that a battle ends, a virtual character on the victorious side can obtain a high reward of upgrade resources, while a virtual character on the defeated side can obtain a low reward of upgrade resources. In another optional manner, the upgrade resource may alternatively be obtained based on duration the controlled virtual character participates in a battle. For example, a virtual character that participates in a battle with longer time can obtain more upgrade resource rewards. The foregoing methods of obtaining the upgrade resource are merely examples. A specific manner of obtaining the upgrade resource in the foregoing aspect of this application is not limited.

In this aspect, a resource exchange control may be displayed to use the material resource owned by the controlled virtual character to obtain the upgrade resource. For example, one unit of material resources of the controlled virtual character may be consumed to obtain one unit of upgrade resources.

The auto chess game is continued to be used as an example to describe the foregoing method. The material resource may be a virtual gold coin, and may be used by the controlled virtual character to purchase the virtual figures to participate in a battle, and may be further used to upgrade the virtual figures. As an optional manner, virtual gold coins owned by the controlled virtual character may also be increased by a specific percentage at the end of each round. For example, before the end of a current battle round, a first controlled virtual character owns 100 virtual gold coins. At the end of the current battle round, the first controlled virtual character may obtain a 10% increase in a quantity of virtual gold coins, to be specific, obtain additional 10 (100*10%) virtual gold coins, leaving a total of 110 virtual gold coins. In this aspect, the virtual character can also use the virtual gold coin to exchange a virtual experience point resource. For example, one virtual gold coin is consumed to obtain one additional virtual experience point.

As a specific manner, the manner of displaying the resource exchange control may be displaying a resource exchange control 301 shown in a lower left corner of FIG. 3, which is an optional display style. The resource exchange control 301 is configured to obtain the upgrade resource by using the material resource owned by the controlled virtual character. In other words, the virtual gold coin may be used to “purchase” the virtual experience point by using the resource exchange control 301.

In another optional manner, the resource exchange control may be displayed at the preparation stage. The resource exchange control is hidden at the battle stage to avoid an accidental touch operation at the battle stage.

In still another optional manner, the resource exchange control is hidden by default at the preparation stage, and in a case that an exchange trigger operation of the virtual character is detected, the resource exchange control is displayed. For example, the resource exchange control may be displayed in response to a double-tap/click operation by the virtual character on the virtual figure.

S206: Determine, in response to a control operation on the resource exchange control, an upgrade interaction state that matches an operation parameter of the control operation.

The control operation may be a touch/press operation, a slide operation, or the like to control the resource exchange control. The touch/press operation may be a touch and hold/long press operation, or may be a tap/click operation. Different upgrade interaction manners may be configured for different types of operations. For example, the tap/click operation may correspond to first upgrade interaction. The touch and hold/long press operation may correspond to second upgrade interaction. The operation parameter may be a duration of the touch and hold/long press operation, or may be a force of the touch and hold/long press operation. In a case that the operation parameter is obtained, an operation mode is further determined based on the operation parameter to determine the upgrade interaction state.

As an optional manner, in a case that the operation duration of the touch/press operation reaches a preset threshold, it may be determined that the upgrade interaction state is a quick upgrade state. In another optional manner, in a case that the operation duration of the touch/press operation does not reach the preset threshold, it may be determined that the upgrade interaction state is a general exchange state.

S208: Upgrade the controlled virtual character from a first level to a second level in a case that the upgrade interaction state indicates that an upgrade acceleration condition is satisfied, and play back an upgrade animation in which the controlled virtual character is upgraded from the current first level to the second level, a quantity of virtual figures allowed to participate in a confrontation at the first level being less than a quantity of virtual figures allowed to participate in a confrontation at the second level.

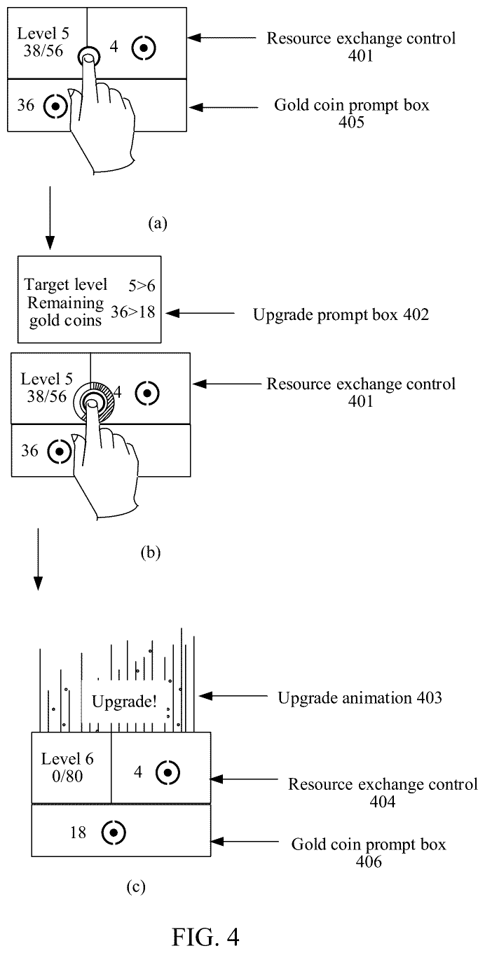

The following describes a specific implementation of the foregoing method with reference to FIG. 4.

As shown in section (a) of FIG. 4, an optional resource exchange control 401 is displayed. A level “level 5” and upgrade information “38/56” of the currently controlled virtual character are displayed in a left box of the resource exchange control 401 and indicate that a total of 56 experience points are required to upgrade from the current level “level 5” to “level 6”, and currently obtained experience points are 38 points. In addition, a number “4” is displayed in a right box of the resource exchange control 401 and indicates that in a case that a tap/click operation is performed on the resource exchange control, in other words, a general exchange operation is performed, four virtual gold coins is consumed to exchange for four experience points. In addition, a gold coin prompt box 405 is displayed under the resource exchange control, and indicates that a quantity of remaining gold coins of the currently controlled virtual character is 36. In this aspect, at the current level, the controlled virtual character is allowed to control four virtual figures to participate in a confrontation.

In a case that a touch and hold/long press operation on the resource exchange control 401 is detected, in other words, it is determined that a trigger condition for a rapid upgrade is reached, an icon shown in section (b) of FIG. 4 is displayed. To be specific, current upgrade progress information is displayed superposing on the resource exchange control 401 by using a ring progress icon. An upgrade prompt box 402 “target level 5>6; and remaining gold coins 36>18” is displayed above the resource exchange control 401 and indicates that a next level to be upgraded is “level 6”, a quantity of currently remaining “gold coins” is 36, and a quantity of remaining “gold coins” after the upgrade is 18. In other words, 18 “gold coins” is consumed to obtain 18 experience points to complete an upgrade interaction operation.

In a case that the ring progress icon in section (b) of FIG. 4 shows that upgrade progress is 100%, a control style in section (c) of FIG. 4 is further displayed. As shown in a resource exchange control 404, a level “level 6” and upgrade information “0/80” of the currently controlled virtual character are displayed in a left box of the resource exchange control 404 and indicate that a total of 80 experience points are required to upgrade from the current level “level 6” to “level 7”, and currently obtained experience points are 0 points. In addition, an upgrade animation 403 is displayed above the resource exchange control 404 and indicates that the upgrade interaction operation of the currently controlled virtual character is completed. In addition, a gold coin prompt box 406 prompts that a quantity of gold coins currently owned by the controlled virtual character is 18. At the current level, the controlled virtual character is allowed to control five virtual figures to participate in a confrontation. In other words, the controlled virtual character is allowed, by increasing a level, to control more virtual figures to participate in a confrontation.

In aspects of the present disclosure, a task picture of a virtual game task of a controlled virtual character is displayed. The virtual game task is a multi-round confrontation task between a plurality of virtual characters. Each round of the multi-round confrontation task is a process in which two virtual characters each select at least one virtual figure to participant in a confrontation. A resource exchange control is displayed in the task picture. The resource exchange control is configured to obtain an upgrade resource by using a material resource owned by the controlled virtual character. An upgrade interaction state that matches an operation parameter of a control operation is determined in response to the control operation on the resource exchange control. The controlled virtual character is upgraded from a first level to a second level in a case that the upgrade interaction state indicates that an upgrade acceleration condition is satisfied, and a corresponding upgrade animation is played back. A quantity of virtual figures allowed to participate in a confrontation at the first level is less than a quantity of virtual figures allowed to participate in a confrontation at the second level. In this way, the upgrade interaction state corresponding to a touch/press operation on the resource exchange control is detected to determine whether an upgrade interaction operation is completed based on a current operation, thereby avoiding a plurality of repeated operations, resolving a technical problem of poor flexibility in an existing upgrade interaction method, and achieving a technical effect of flexible upgrade based on a touch/press operation parameter.

As an optional implementation, the foregoing S206: Determine, in response to a control operation on the resource exchange control, an upgrade interaction state that matches an operation parameter of the control operation includes:

S1: Obtain the operation parameter of the control operation in response to the control operation on the resource exchange control.

S2: Determine, in a case that the operation parameter satisfies an upgrade acceleration trigger condition, to trigger an upgrade acceleration mode, and obtain a resource value of a material resource currently owned by the controlled virtual character.

S3: Determine, in a case that the resource value of the material resource currently owned by the controlled virtual character reaches a target material resource value, that the upgrade interaction state satisfies the upgrade acceleration condition, the target material resource value being determined based on a resource value of an upgrade resource that matches the second level, and the second level being adjacent to the first level.

In a possible implementation, the control operation includes a touch/press operation, and the operation parameter includes at least one of the following: touch/press duration or touch/press pressure.

In a case that a touch/press operation on the resource exchange control is detected, it is determined, based on obtained touch/press duration and touch/press pressure, whether a current touch/press operation is a touch and hold/long press operation. Specifically, in a case that the touch/press pressure reaches a first threshold, it is determined that the touch/press operation on the resource exchange control is obtained. In a case that the touch/press pressure does not reach the first threshold, it is determined that the touch/press operation on the resource exchange control is not obtained.

In a case that it is determined that the touch/press operation on the resource exchange control is obtained, a touch/press duration parameter is obtained. In a case that touch/press duration reaches a first threshold, it is determined that the upgrade acceleration trigger condition is satisfied. In a case that the touch/press duration does not reach the first threshold, it is determined that the currently obtained touch/press operation is a single-tap/click operation, in other words, a general exchange operation is performed. Specifically, one exchange operation consumes four virtual gold coins to obtain four experience points.

Further, the upgrade acceleration mode is determined, in a case that the operation parameter satisfies the upgrade acceleration trigger condition, to be triggered, and the resource value of the material resource currently owned by the controlled virtual character is obtained. A quantity of material resources currently owned by the controlled virtual character may be compared with a quantity of material resources required for a rapid upgrade to a next level. In a case that the quantity of currently owned material resources is greater than or equal to the quantity of material resources required for the rapid upgrade to the next level, it is determined that the upgrade acceleration condition is satisfied.

For example, in a case that a quantity of virtual gold coins owned by the currently controlled virtual character is 100, and experience points required for a current level to upgrade to a next level is 50, assuming that one virtual gold coin may be used to exchange one experience point, a quantity of gold coins required for the upgrade to the next level is 50 that is less than the quantity of virtual gold coins owned by the currently controlled virtual character. Further, in a case that it is determined that the resource value of the material resource currently owned by the controlled virtual character reaches a target material resource value, it is determined that the upgrade interaction state satisfies the upgrade acceleration condition.

In another aspect, in a case that the quantity of virtual gold coins owned by the currently controlled virtual character is 25, and the experience points required for the current level to upgrade to the next level is 50, the quantity of gold coins required for the upgrade to the next level is 50 that is greater than the quantity of virtual gold coins owned by the currently controlled virtual character, it is further determined that the upgrade interaction state does not satisfy the upgrade acceleration condition. As an optional manner, in a case that the upgrade acceleration condition is not satisfied, “Sorry, a quantity of current gold coins is insufficient” may be displayed to prompt that an upgrade acceleration operation fails.

In one aspect, a level that can be improved by the upgrade acceleration operation is level 1. If upgrade acceleration is needed again, a second touch and hold/long press operation needs to be performed to trigger the upgrade acceleration. In this way, consuming all material resources excessively quickly due to an accidental touch operation by a player which affects operation experience is avoided.

According to the foregoing implementation of this application, the operation parameter of the touch/press operation is obtained in response to the touch/press operation on the resource exchange control. The operation parameter includes at least one of the following: the touch/press duration or the touch/press pressure. The upgrade acceleration mode is determined, in a case that the operation parameter satisfies the upgrade acceleration trigger condition, to be triggered, and the resource value of the material resource currently owned by the controlled virtual character is obtained. It is determined, in a case that the resource value of the material resource currently owned by the controlled virtual character reaches the target material resource value, that the upgrade interaction state satisfies the upgrade acceleration condition. The target material resource value is determined based on the resource value of the upgrade resource that matches the second level, and the second level is adjacent to the first level. In this way, it is determined, based on the touch/press operation parameter, whether to trigger the upgrade acceleration mode. Further, an upgrade manner of a general exchange and an upgrade manner of a rapid upgrade can be combined to improve flexibility of an upgrade interaction process for a game task.

As an optional implementation, after the obtaining the operation parameter of the touch/press operation, the method further includes:
determining, in a case that the touch/press duration in the operation parameter is greater than or equal to target duration, that the operation parameter satisfies the upgrade acceleration trigger condition, and determining to trigger the upgrade acceleration mode; and/or determining, in a case that the touch/press pressure in the operation parameter is
greater than or equal to a target pressure value, that the operation parameter satisfies the upgrade acceleration trigger condition, and determining to trigger the upgrade acceleration mode.

In this aspect, it may be determined, based on the touch/press duration, whether to trigger the upgrade acceleration mode. It is determined, in a case that the touch/press duration is greater than or equal to the target duration, that the operation parameter satisfies the upgrade acceleration trigger condition, and the upgrade acceleration mode is determined to be triggered. It is determined, in a case that the touch/press duration is less than the target duration, that the operation parameter does not satisfy the upgrade acceleration trigger condition, and a general upgrade mode is determined to be triggered. In other words, it is determined, based on the touch/press duration, that the current touch/press operation is a tap/click operation. In response to the tap/click operation, a fixed quantity of material resources is consumed to obtain a fixed quantity of upgrade resources.

In this aspect, it may be further determined, based on the touch/press pressure, whether to trigger the upgrade acceleration mode. It is determined, in a case that the touch/press pressure is greater than or equal to the target pressure value, that the operation parameter satisfies the upgrade acceleration trigger condition, and the upgrade acceleration mode is determined to be triggered. It is determined, in a case that the touch/press pressure is less than the target pressure, that the operation parameter does not satisfy the upgrade acceleration trigger condition, and the general upgrade mode is determined to be triggered. In other words, it is determined, based on the touch/press pressure, that the current touch/press operation is a tap/click operation. In response to the tap/click operation, a fixed quantity of material resources is consumed to obtain a fixed quantity of upgrade resources.

According to the foregoing implementation of this application, it is determined, in a case that the touch/press duration in the operation parameter is greater than or equal to the target duration, that the operation parameter satisfies the upgrade acceleration trigger condition, and the upgrade acceleration mode is determined to be triggered; and/or it is determined, in a case that the touch/press pressure in the operation parameter is greater than or equal to the target pressure value, that the operation parameter satisfies the upgrade acceleration trigger condition, and the upgrade acceleration mode is determined to be triggered. In this way, it is accurately determined, based on the touch/press operation parameter, whether to trigger the upgrade acceleration mode. Further, an upgrade manner of a general exchange and an upgrade manner of a rapid upgrade can be combined to improve flexibility of an upgrade interaction process for a game task.

As an optional implementation, after the obtaining the resource value of the material resource currently owned by the controlled virtual character, the method further includes: determining, in a case that the resource value of the material resource currently owned by the controlled virtual character does not reach the target material resource value, that the upgrade interaction state does not satisfy the upgrade acceleration condition, and displaying prompt information configured for prompting that the controlled virtual character fails to be upgraded.

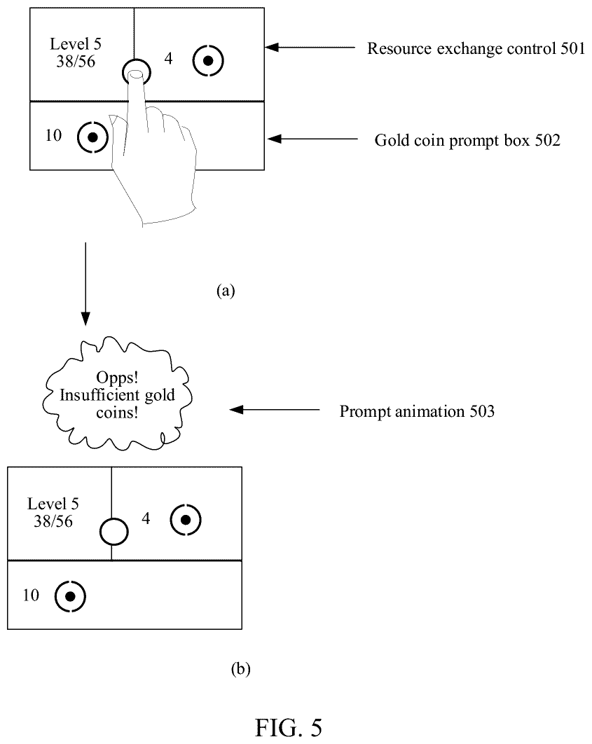

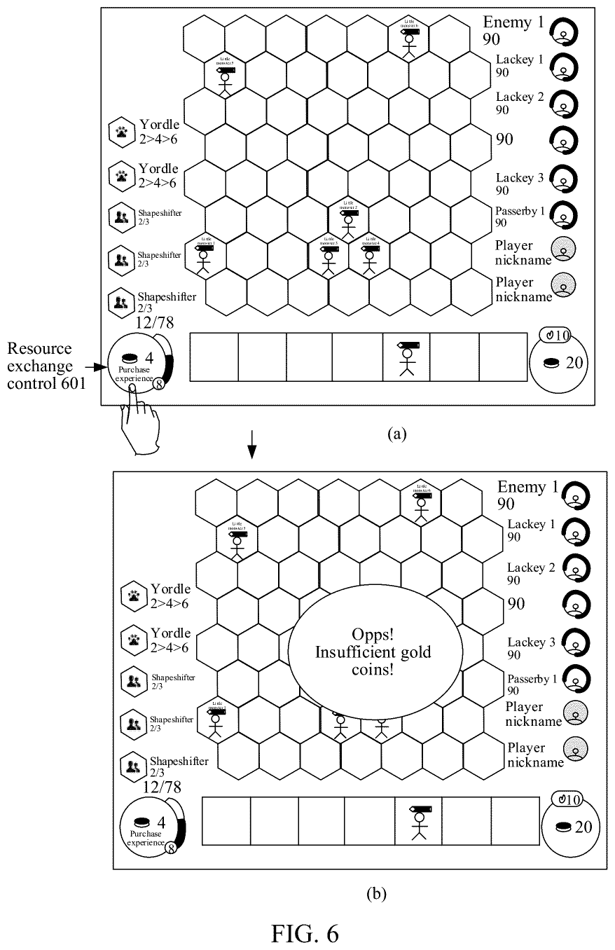

The following describes two optional specific implementations of the foregoing method with reference to FIG. 5 and FIG. 6. As shown in section (a) of FIG. 5, as indicated in a resource exchange control 501, experience points required for an upgrade to a next level is 18 points. In other words, 18 gold coins are required for a rapid upgrade. A gold coin prompt box 502 indicates that a quantity of virtual gold coins currently owned by the controlled virtual character is 10 that does not satisfy a requirement of exchanging at least 18 virtual gold coins for 18 experience points to upgrade to the next level. In a case that a touch and hold/long press operation on the resource exchange control 501 is detected, an icon interface shown in section (b) of FIG. 5 is displayed. To be specific, a prompt animation 503 “Opps! Insufficient gold coins” is displayed above the resource exchange control, that is, the prompt information configured for prompting that the controlled virtual character fails to be upgraded.

The following describes another optional implementation with reference to FIG. 6. As shown in section (a) of FIG. 6, in a case that a touch and hold/long press operation of a resource exchange control 601 is detected, in a case that a quantity of virtual gold coins owned by the currently controlled virtual character does not satisfy a minimum quantity of gold coins required for an upgrade to a next level, a game scene interface as shown in section (b) of FIG. 6 is displayed. To be specific, a prompt animation “Opps! Insufficient gold coins” is displayed on the scene interface, that is, the prompt information configured for prompting that the controlled virtual character fails to be upgraded.

According to the foregoing implementation of this application, it is determined, in a case that the resource value of the material resource currently owned by the controlled virtual character does not reach the target material resource value, that the upgrade interaction state does not satisfy the upgrade acceleration condition, and the prompt information configured for prompting that the controlled virtual character fails to be upgraded is displayed. In this way, in a case that the resource value of the material resource does not satisfy the upgrade acceleration condition, related prompt information is displayed, to improve interaction efficiency of upgrade interaction.

As an optional implementation, the upgrading the controlled virtual character from a first level to a second level in a case that the upgrade interaction state indicates that an upgrade acceleration condition is satisfied, and playing back a corresponding upgrade animation includes:

S1: Play back an upgrade buffer progress prompt animation in a case that the upgrade interaction state indicates that the upgrade acceleration condition is satisfied, the upgrade buffer progress prompt animation being configured for dynamically prompting buffer progress of upgrading the first level.

S2: Determine, in a case that playback of the upgrade buffer progress prompt animation ends, that upgrade buffer for the first level is completed, upgrade the first level to the second level, and display prompt information indicating that the controlled virtual character is upgraded successfully.

In this aspect, the upgrade buffer progress prompt animation is played back to indicate the progress of the upgrade buffer. As an optional display manner, the upgrade buffer progress prompt animation may be displayed by using a ring progress icon. A percentage of a highlighted part in the ring to the entire ring indicates a current buffered proportion. In another optional manner, the upgrade buffer progress prompt animation may alternatively be displayed by using a bar progress icon. A highlighted part in the bar indicates current upgrade buffer progress. In another optional manner, the upgrade buffer progress prompt animation may be displayed by using a pie progress icon. The foregoing display manners for the buffer progress prompt animation are merely examples, and do not constitute limitations on a buffer animation actually used in this aspect.

As an optional manner, playback duration of the prompt animation may be fixed duration, and the upgrade is determined to be completed after the playback of the buffer animation with fixed duration ends. In another optional manner, the playback duration of the foregoing prompt animation may be non-fixed duration. Specific duration of the non-fixed duration may be determined based on remaining experience points required for the controlled virtual character to upgrade to a next level. For example, more required remaining experience points indicates longer playback duration of the prompt animation. The foregoing determining manners for the playback duration of the prompt animation are merely examples, and do not constitute limitations on a determining manner for actual animation duration.

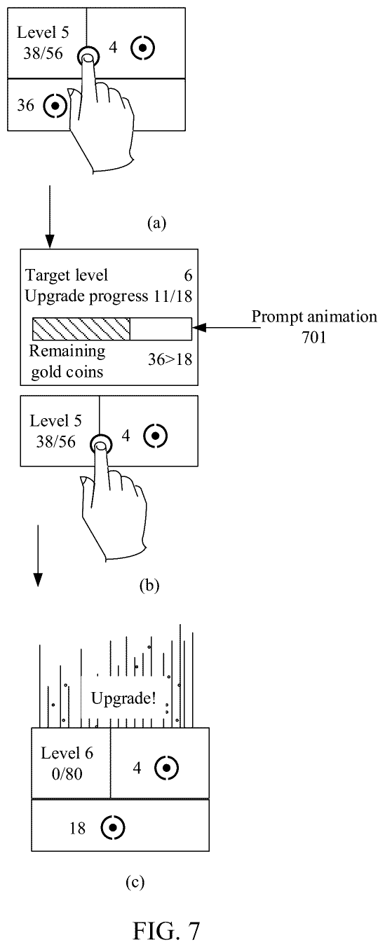

Specifically, the ring progress icon shown in section (b) of FIG. 4 is an optional display form of an upgrade buffer animation. To be specific, a buffer ring is displayed near a touch/press point, and a highlighted part indicates progress that buffer is already completed. FIG. 7 shows another optional display manner for the upgrade buffer animation. As shown in section (a) of FIG. 7, in response to a touch and hold/long press operation on the resource exchange control, an icon style as shown in section (b) of FIG. 7 is displayed. For example, in a prompt animation 701, current buffer progress of 11/18 is displayed in a horizontal bar icon, and indicates that a total of 18 experience points are required to upgrade to a next level, 11 experience points is obtained currently, and 7 experience points are left to complete a rapid upgrade. In a case that the prompt animation 701 indicates that buffer is completed, an icon style prompting a successful upgrade as shown in section (c) of FIG. 7 is displayed.

According to the foregoing implementation of this application, the upgrade buffer progress prompt animation is played back in a case that the upgrade interaction state indicates that the upgrade acceleration condition is satisfied. The upgrade buffer progress prompt animation is configured for dynamically prompting buffer progress of upgrading the first level. It is determined, in a case that the playback of the upgrade buffer progress prompt animation ends, that the upgrade buffer for the first level is completed, the first level is upgraded to the second level, and the prompt information prompting that the controlled virtual character is upgraded successfully is displayed. In this way, progress information of current upgrade buffer is prompted in the form of animation to improve operation accuracy of a rapid upgrade operation.

As an optional implementation, during the playing back an upgrade buffer progress prompt animation, the method further includes: canceling the upgrade buffer of the first level in a case that the control operation on the resource exchange control is interrupted, and maintaining resource values of both a material resource and an upgrade resource owned by the controlled virtual character before the control operation.

In this implementation, for example, the control operation is a touch/press operation. When a touch and hold/long press operation on the resource exchange control is detected, an upgrade buffer animation is displayed to indicate progress of current buffer. In a case that the touch and hold/long press operation is interrupted, the currently controlled virtual character is instructed to cancel this rapid upgrade operation, to control the material resource and the upgrade resource of the controlled virtual character to maintain at values before the resource exchange control is triggered.

According to the foregoing implementation of this application, the upgrade buffer of the first level is canceled in a case that the touch/press operation on the resource exchange control is interrupted, and the resource values of both the material resource and the upgrade resource owned by the controlled virtual character before the touch/press operation are maintained. In this way, an operation manner of canceling a rapid upgrade is provided for the controlled virtual character, to avoid loss of material resources caused by the controlled virtual character due to an accidental touch operation, and improve accuracy of an upgrade interaction operation.

As an optional implementation, the playing back an upgrade buffer progress prompt animation includes one of the following:
determining first playback duration that matches a level of the second level; and playing back the upgrade buffer progress prompt animation based on the first playback duration; or
determining a difference between a resource value of an upgrade resource that matches the second level and a resource value of an upgrade resource currently owned by the controlled virtual character; and playing back the upgrade buffer progress prompt animation based on second playback duration that matches the difference.

In the first manner of this aspect, animation duration of the upgrade buffer progress prompt animation is related to a to-be-upgraded level. A higher level indicates longer animation duration, that is, longer buffer duration. In a specific manner, for example, the control operation is a touch/press operation, and animation duration during a rapid upgrade from level 5 to level 6 corresponds to “level 6” and is assumed to be 1 s. Further, animation duration during a rapid upgrade from level 6 to level 7 corresponds to “level 7” and is assumed to be 1.2 s. In other words, a touch and hold/long press operation with longer time needs to be detected to trigger a rapid upgrade operation from level 6 to level 7.

In the second manner of this aspect, the animation duration of the upgrade buffer progress prompt animation is related to a difference in an upgrade resource value required for a current rapid upgrade. A greater difference indicates longer animation duration of the upgrade buffer progress prompt animation. In a specific manner, for example, the control operation is a touch/press operation, current experience points of the controlled virtual character are 20, and a total of experience points required to upgrade from level 5 to level 6 are 30. Therefore, required remaining experience points are 10. In this way, it is determined that the animation duration of the upgrade buffer progress prompt animation is 0.1 times of 10, that is, Is. Assuming that the current experience points of the controlled virtual character are 30, and a total of experience points required to upgrade from level 6 to level 7 are 35, the required remaining experience points are 5. In this way, it is determined that the animation duration of the upgrade buffer progress prompt animation is 0.1 times of 5, that is, 0.5 s. In other words, in this implementation, more required remaining experience points indicate a touch and hold/long press operation with longer time that needs to be detected to complete the rapid upgrade operation.

According to the foregoing implementation of this application, the first playback duration that matches the level of the second level is determined. The upgrade buffer progress prompt animation is played back based on the first playback duration. The difference between the resource value of the upgrade resource that matches the second level and the resource value of the upgrade resource currently owned by the controlled virtual character is determined. The upgrade buffer progress prompt animation is played back based on the second playback duration that matches the difference. In this way, a plurality of manners of playing back the upgrade buffer animation are provided, to improve flexibility of the upgrade interaction operation.

As an optional implementation, after the determining an upgrade interaction state that matches an operation parameter of the control operation, the method further includes:

S1: Determine a difference between a resource value of an upgrade resource that matches the second level and a resource value of an upgrade resource currently owned by the controlled virtual character.

S2: Determine, in a case that a first reference resource value of an upgrade resource of the controlled virtual character is greater than or equal to the difference, that the upgrade interaction state satisfies the upgrade acceleration condition, the first reference resource value being a resource value of the upgrade resource obtained by allowing a resource value of a material resource currently owned by the controlled virtual character to be exchanged.

In this aspect, after the upgrade interaction state that matches the operation parameter of the touch/press operation is determined, the first reference resource value of the upgrade resource obtained by allowing the resource value of the material resource currently owned by the controlled virtual character to be exchanged is compared with the difference between the resource value of the upgrade resource that matches the second level and the resource value of the upgrade resource currently owned by the controlled virtual character to determine whether a current rapid upgrade operation is completed. In a case that a numerical relationship between the first reference resource value and the difference satisfies that a reference resource value obtained by exchanging the resource value of the material resource is greater than or equal to the foregoing difference, it is determined that the rapid upgrade operation can be implemented.

According to the foregoing implementation of this application, the difference between the resource value of the upgrade resource that matches the second level and the resource value of the upgrade resource currently owned by the controlled virtual character is determined. In a case that the first reference resource value of the upgrade resource obtained by allowing the resource value of the material resource currently owned by the controlled virtual character to be exchanged is greater than or equal to the difference, it is determined that the upgrade interaction state satisfies the upgrade acceleration condition. In this way, a possibility of implementing the rapid upgrade operation is accurately determined based on comparison between the first reference resource value and the difference, to improve the flexibility of the upgrade interaction operation.

As an optional implementation, the upgrading the controlled virtual character from a first level to a second level in a case that the upgrade interaction state indicates that an upgrade acceleration condition is satisfied, and playing back a corresponding upgrade animation includes: upgrading the controlled virtual character from the first level to the second level in a case that the upgrade interaction state indicates that the upgrade acceleration condition is satisfied, and playing back an upgrade progress prompt animation, the upgrade progress prompt animation being configured for dynamically prompting upgrade progress from the first level to the second level.

In this aspect, current upgrade progress is dynamically prompted through the progress prompt animation. In other words, in this implementation, in response to a touch and hold/long press operation on the resource exchange control, a specific quantity of experience points can be exchanged every interval, and a real-time exchange process is displayed in the form of animation.

According to the foregoing implementation of this application, the upgrade progress prompt animation is played back in a case that the upgrade interaction state indicates that the upgrade acceleration condition is satisfied. The upgrade progress prompt animation is configured for dynamically prompting upgrade progress of upgrade from the first level to the second level. In this way, real-time progress of a resource exchange is prompted in a case that the touch and hold/long press operation is performed on the resource exchange control, to implement flexible control on the upgrade interaction operation.

As an optional implementation, the playing back an upgrade progress prompt animation includes:

S1: Determine a time interval of continuous operation duration of the control operation.

S2: Exchange material resources per unit of resource value for upgrade resources based on an exchange interval that matches the time interval, longer continuous operation duration indicating a smaller exchange interval.

S3: Dynamically determine upgrade progress in the upgrade progress prompt animation based on an exchange result.

In this aspect, the upgrade resource value of the controlled virtual character is updated in real time. For example, the control operation is the touch and hold/long press operation in the touch/press operation. Assuming that the touch and hold/long press operation is interrupted, exchanged experience is not withdrawn, consumed virtual gold coins are not returned, and the current upgrade progress is remained. In addition, an exchange speed of exchanging the material resource for the upgrade resource increases with a length of operation duration of the touch and hold/long press operation.

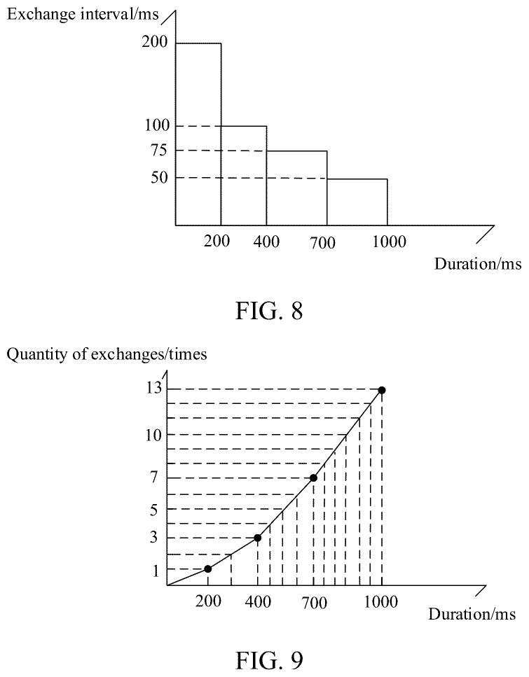

The following describes the foregoing method with reference to FIG. 7 and FIG. 8. As shown in FIG. 7, for example, the control operation is the touch and hold/long press operation in the touch/press operation. As duration of the touch and hold/long press increases, an exchange interval of exchanging the virtual gold coin for a virtual resource decreases. As shown in FIG. 8, in a first duration period (0, 200 ms), and a corresponding exchange interval is 200 ms. In other words, in a case that a touch and hold/long press operation with duration of 200 ms is detected, an exchange between the virtual gold coin and the virtual resource occurs once. In a second duration period (200 ms, 400 ms), a corresponding exchange period is 100 ms. This means that an exchange operation occurs twice within the second duration period (of which duration is 200 ms). In a third duration period (400 ms, 700 ms), a corresponding exchange period is 75 ms. This means that the exchange operation occurs four times within the third duration period (of which duration is 300 ms). In a fourth duration period (700 ms, 1000 ms), a corresponding exchange period is 50 ms. This means that the exchange operation occurs six times within the fourth duration period (of which duration is 300 ms).

Further, a schematic diagram of a linear relationship between touch/press duration and a quantity of exchanges is shown in FIG. 9. In FIG. 9, it may be determined that a first exchange operation occurs in a case that the touch and hold/long press operation lasts for 200 ms. A total of exchange operations occur seven times in a case that the touch and hold/long press operation lasts for 700 ms. As shown in the figure, as the touch/press duration increases, the exchange speed becomes faster and the exchange period becomes shorter.

In a case that the quantity of exchanges is obtained, a quantity of resource values for each exchange is further obtained. Further, a quantity of resource values that are exchanged as the touch/press duration increases may be determined. Then, current exchange upgrade progress is displayed through the upgrade progress in the upgrade progress prompt animation.

According to the foregoing implementation of this application, the time interval of the continuous operation duration of the control operation is determined. Material resources per unit of resource value are exchanged for upgrade resources based on an exchange interval that matches the time interval. Longer continuous operation duration indicates a smaller exchange interval. The upgrade progress in the upgrade progress prompt animation is dynamically determined based on the exchange result. In this way, a relationship between control duration and the quantity of exchanges is accurately determined, and the accuracy of the upgrade interaction operation is improved.

As an optional implementation, during the playing back an upgrade progress prompt animation, the method further includes: canceling upgrade of the first level in a case that the control operation on the resource exchange control is interrupted, updating the material resource owned by the controlled virtual character to a remaining resource value at the time of the interruption, and suspending the upgrade progress prompt animation at upgrade progress reached at the time of the interruption.

In this aspect, touching and holding/long pressing the resource exchange control can implement a real-time exchange of a resource, until the current rapid upgrade operation is completed. In a case that the current rapid upgrade operation is not completed and it is detected that the touch and hold/long press operation is interrupted, a resource value that is exchanged at the time of the interruption is a final state, and the material resource and the upgrade resource of the controlled virtual character are updated.

According to the foregoing implementation of this application, the upgrade of the first level is canceled in a case that the control operation on the resource exchange control is interrupted, the material resource owned by the controlled virtual character is updated to the remaining resource value at the time of the interruption, and the upgrade progress prompt animation is suspended at the upgrade progress reached at the time of the interruption. In this way, an operation manner of accurately determining exchange upgrade progress based on start and stop of the control operation at any time is provided, and the flexibility of the upgrade interaction operation is improved.

As an optional implementation, after the canceling the upgrade of the first level, the method further includes: continuing to update, in a case that the control operation on the resource exchange control is resumed, the upgrade progress in the upgrade progress prompt animation by using the upgrade progress reached at the time of the interruption as a starting point.

In this aspect, for example, the control operation is the touch and hold/long press operation in the touch/press operation. In a case that the touch and hold/long press operation is interrupted, a real-time exchange upgrade operation can be continued based on a next touch and hold/long press operation. In an optional manner, an exchange rate of a resumed touch and hold/long press operation can continue to increase based on a last interrupted touch and hold/long press operation. The following describes the foregoing method with reference to FIG. 8. For example, in a process of touching and holding/long pressing at level 5 to upgrade to level 6, duration of a first touch and hold/long press operation is 200 ms, and a corresponding exchange speed is 200 ms/time, in this case, an exchange operation is implemented once. After the first touch and hold/long press operation is interrupted, duration of a second touch and hold/long press operation is 200 ms, and a corresponding exchange rate can be continuously calculated based on the first touch and hold/long press operation. To be specific, it is determined that the duration of the second touch and hold/long press operation is within a period of 200 ms to 400 ms, and a corresponding exchange speed is 100 ms/time, in this case, the exchange is implemented twice.

In another optional implementation, the exchange rate of the resumed touch and hold/long press operation needs to be recalculated. The following continues to describe the foregoing method with reference to FIG. 8. For example, in a process of touching and holding/long pressing at level 5 to upgrade to level 6, duration of a first touch and hold/long press operation is 200 ms, and a corresponding exchange speed is 200 ms/time, in this case, an exchange operation is implemented once. After the first touch and hold/long press operation is interrupted, the duration of the second touch and hold/long press operation is 200 ms, and the corresponding exchange rate needs to be recalculated. To be specific, it is determined that the duration of the second touch and hold/long press operation is within a period of 0 ms to 200 ms, and the corresponding exchange speed is 200 ms/time, in this case, the exchange is implemented once.

According to the foregoing implementation of this application, the upgrade progress in the upgrade progress prompt animation is continued, in a case that the control operation on the resource exchange control is resumed, to be updated by using the upgrade progress reached at the time of the interruption as the starting point. In this way, the operation manner of accurately determining the exchange upgrade progress based on the start and stop of the control operation at any time is provided to improve the flexibility of the upgrade interaction operation.

As an optional implementation, during the playing back a corresponding upgrade animation, the method further includes: prompting that the controlled virtual character is about to be upgraded to the second level, and displaying a remaining resource value of the material resource owned by the controlled virtual character after the upgrade.

The following describes the foregoing method with reference to FIG. 4. In a case that the ring progress icon in section (b) of FIG. 4 shows that upgrade progress is 100%, a control style in section (c) of FIG. 4 is further displayed. As shown in a resource exchange control 404, a level “level 6” and upgrade information “0/80” of the currently controlled virtual character are displayed in a left box of the resource exchange control 404 and indicate that a total of 80 experience points are required to upgrade from the current level “level 6” to “level 7”, and currently obtained experience points are 0 points. In addition, a gold coin prompt box 406 prompts that a quantity of remaining gold coins after the upgrade is 18.

According to the foregoing implementation of this application, that the controlled virtual character is about to be upgraded to the second level is prompted, and the remaining resource value of the material resource owned by the controlled virtual character after the upgrade is displayed, thereby improving display efficiency of the upgrade interaction operation.

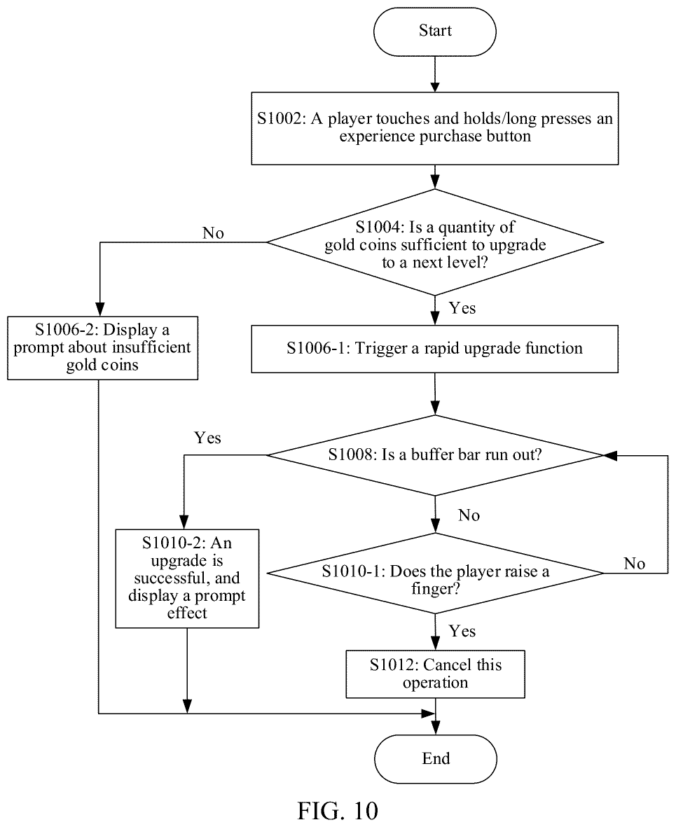

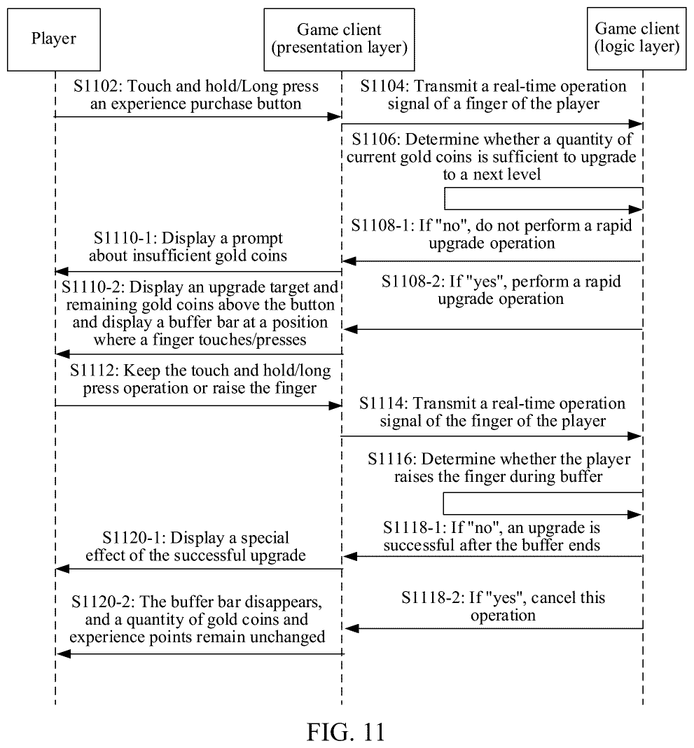

The following describes a specific implementation with reference to FIG. 10 and FIG. 11. In this aspect, an example in which the control operation is the touch and hold/long press operation in the touch/press operation is used for description.

As shown in a flowchart in FIG. 10, operation S1002: A player touches and holds/long presses an experience purchase button.

Specifically, it may be determined, based on duration that the player touches and holds/long presses the experience purchase button, whether to trigger a rapid upgrade function. In a case that the duration reaches a duration threshold, the rapid upgrade function is determined to be triggered.

Operation S1004: Determine whether a quantity of gold coins is sufficient to upgrade to a next level. In a case that the quantity of gold coins is sufficient to upgrade to the next level, operation S1006-1 is performed: Trigger the rapid upgrade function. In a case that the quantity of gold coins is insufficient to upgrade to the next level, operation S1006-2 is performed: Display a prompt about insufficient gold coins.

Operation S1004 may be implemented by a server system. After a server returns a determining result to a terminal, the terminal performs operation S1006-1 or operation S1006-2 based on the feedback result.

During performing operation S1006-1, as shown in FIG. 4, a current upgrade target and a quantity of remaining gold coins may be displayed above the button to facilitate reading of a player. In addition, a trigger buffer bar (which is ring-shaped, horizontal, or vertical, the ring-shape is used as an example in FIG. 4) is displayed at a position where a finger touches/presses.

Operation S1008: Determine whether a buffer bar is run out. In a case that the buffer bar is run out, operation S1010-2 is performed: An upgrade is successful, display a prompt effect. In a case that the buffer bar is not run out, operation S1010-1 is performed: Determine whether the player raises a finger. In a case that the player raises the finger, operation S1012 is performed: Cancel this operation. In a case that the player does not raise the finger, operation S1008 is performed again.

Specifically, the player can complete the upgrade by touching/pressing the button until the buffer bar is run out, and a special effect of the successful upgrade is displayed. In this aspect, in this case, an upgrade operation is completed and is not triggered if the button is continued to be touched/pressed. If the upgrade is needed to be continued, the finger needs to be taken off a screen and touches and presses the screen again to trigger the upgrade operation again. In addition, if the player raises the finger midway, a rapid upgrade operation is canceled, and a current gold coin value and experience points are not changed.

If a system determines that a quantity of current gold coins of the player is insufficient to upgrade to a next level, after the player touches/presses the experience purchase button for a specific period of time, the rapid upgrade function is not triggered, but a corresponding prompt is given. The prompt may appear near the button or in the center of the screen.

The following further describes the foregoing method with reference to a sequence diagram shown in FIG. 11.

S1102: A player touches and holds/long presses an experience purchase button. S1104: A presentation layer transmits a real-time operation signal of a finger of the player to a logic layer. S1106: The logic layer determines whether a quantity of current gold coins is sufficient to upgrade to a next level. S1108-1: If “no”, do not perform a rapid upgrade operation. Then S1110-1 is performed: The presentation layer displays a prompt about “Insufficient gold coins”. S1108-2: If “yes”, perform a rapid upgrade operation. Then S1110-2 is performed: The presentation layer displays an upgrade target and remaining gold coins above the button; and displays a trigger buffer bar at a position where a finger touches/presses.

S1112: The player keeps a touch and hold/long press operation or raises the finger. S1114: The presentation layer transmits a real-time operation signal of the finger of the player to the logic layer. S1116: The logic layer determines whether the player raises the finger during buffer. S1118-1: If “no”, an upgrade is successful after the buffer ends. S1120-1: The presentation layer displays a corresponding prompt effect. S1118-2: If “yes”, cancel this operation. S1120-2: The presentation layer controls the buffer bar to disappear, and a quantity of gold coins and experience points remain unchanged.

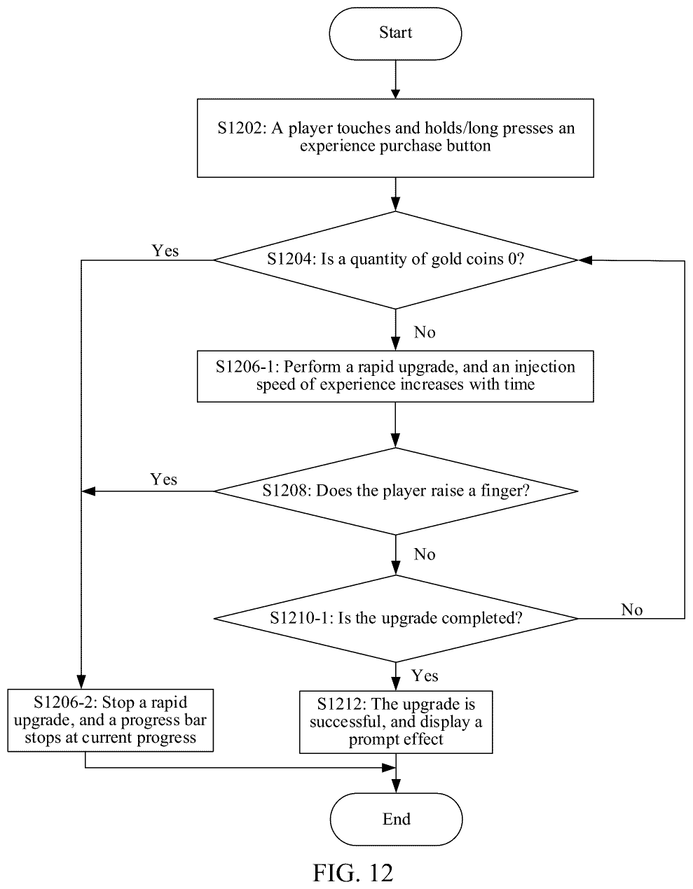

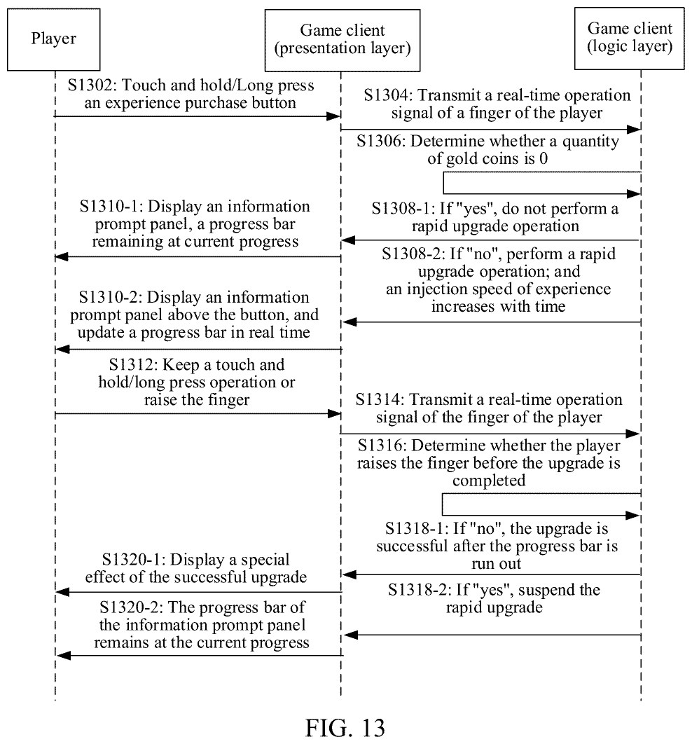

The following describes another specific implementation with reference to FIG. 12 and FIG. 13.

Operation S1202: A player touches and holds/long presses an experience purchase button.

Specifically, it may be determined, based on duration that the player touches and holds/long presses the experience purchase button, whether to trigger a rapid upgrade function. In a case that the duration reaches a duration threshold, the rapid upgrade function is determined to be triggered.

Then operation S1204 is performed: Determine whether a quantity of gold coins is 0. In a case that it is determined that the quantity of gold coins is 0, operation S1206-2 is performed: Stop a rapid upgrade, and a progress bar stops at current progress. In a case that the quantity of gold coins is not 0, S1206-1 is performed: Perform the rapid upgrade, and an injection speed of experience increases with time.

Specifically, if “yes”, the rapid upgrade is not performed, a progress bar of an information prompt panel remains at current progress. If “no”, the rapid upgrade (where the information prompt panel is displayed above the button and the progress bar is updated in real time) is performed, and the injection speed of the experience increases with touch/press time. As shown in FIG. 7, after the player touches/presses the purchase experience button for a specific period of time, the rapid upgrade function is triggered. In this case, the system performs the following operation: displaying the information prompt panel above the button. Experience is automatically purchased for the player at a specific unit time interval (X ms), and as the touch/press time increases, an exchange time interval shortens. A relationship between duration of touch and hold/long press and the exchange time interval may be shown in FIG. 8.

Then operation S1208 is performed: Determine whether the player raises a finger. In a case that the player raises the finger, operation S1206-2 is performed: Stop the rapid upgrade, and the progress bar stops at the current progress. In a case that the finger is not raised, the operation S1210-1 is performed: Determine whether the upgrade is completed. If the upgrade is completed, operation S1212 is performed: The upgrade is successful, and display a prompt effect. If the upgrade is not completed, operation S1204 is performed again.

Specifically, in this aspect, after the button is touched/pressed, the experience is automatically exchanged until the upgrade is completed, and a special effect of the successful upgrade is displayed. According to a rule, in this case, an upgrade operation is completed and is not triggered if the button is continued to be touched/pressed. If the upgrade is needed to be continued, the finger needs to be taken off a screen and touches and presses the screen again to trigger the upgrade operation again. An experience exchange is carried out in real time throughout the process. If the player lets go midway, the exchange is stopped and the current progress is retained. Consumed gold coins are not returned, and obtained experience is not taken back. If the gold coins of the player are insufficient to upgrade to a next level, the progress bar remains at time the gold coins of the player are run out. Although the upgrade is unsuccessful, the consumed gold coins are not returned, and the obtained experience is not taken back.

The following further describes the foregoing method with reference to a sequence diagram of FIG. 13.

S1302: A player touches and holds/long presses an experience purchase button. S1304: A presentation layer transmits a real-time operation signal of a finger of the player to a logic layer. S1306: The logic layer determines whether a quantity of current gold coins is 0. S1308-1: If “yes”, do not perform a rapid upgrade operation. S1310-1: The presentation layer displays an information prompt panel, a progress bar remaining at current progress. S1308-2: If “no”, perform the rapid upgrade operation, and an injection speed of experience increases with time. S1310-2: The presentation layer displays the information prompt panel above the button, and updates the progress bar in real time.

S1312: The player keeps a touch and hold/long press operation or raises the finger. S1314: A presentation layer transmits a real-time operation signal of a finger of the player to a logic layer. S1316: The logic layer determines whether the player raises the finger before the upgrade is completed. S1318-1: If “no”, the upgrade is completed after the progress bar is run out. S1320-1: The presentation layer displays a special effect of the successful upgrade. S1318-2: If “yes”, suspend the rapid upgrade. S1320-2: The progress bar of the information prompt panel remains at the current progress.

In aspects of the present disclosure, a task picture of a virtual game task in which a controlled virtual character currently participates is displayed, the virtual game task being a multi-round confrontation task between a plurality of virtual characters, and each round of the multi-round confrontation task being a process in which two virtual characters each select at least one virtual figure to participant in a confrontation; a resource exchange control is displayed in the task picture, the resource exchange control being configured to obtain an upgrade resource by using a material resource owned by the controlled virtual character; an upgrade interaction state that matches an operation parameter of a touch/press operation is determined in response to the touch/press operation on the resource exchange control; and an upgrade animation in which the controlled virtual character is upgraded from a current first level to a second level is played back in a case that the upgrade interaction state indicates that an upgrade acceleration condition is satisfied, a quantity of virtual figures allowed to participate in a confrontation at the first level being less than a quantity of virtual figures allowed to participate in a confrontation at the second level. In this way, the upgrade interaction state corresponding to a touch/press operation on the resource exchange control is detected to determine whether an upgrade interaction operation is completed based on a current operation, thereby avoiding a plurality of repeated operations, resolving a technical problem of poor flexibility in an existing upgrade interaction method, and achieving a technical effect of flexible upgrade based on a touch/press operation parameter.

For each of the foregoing method aspects, for case of description, the method aspects are described as a series of action combination. But a person skilled in the art is to know that the present disclosure is not limited to any described sequence of the action, as some operations can use other sequences or can be executed simultaneously according to the present disclosure. In addition, a person skilled in the art is also to know that all aspects described in the specification are exemplary aspects, and the related actions and modules are not necessarily mandatory to the present disclosure.

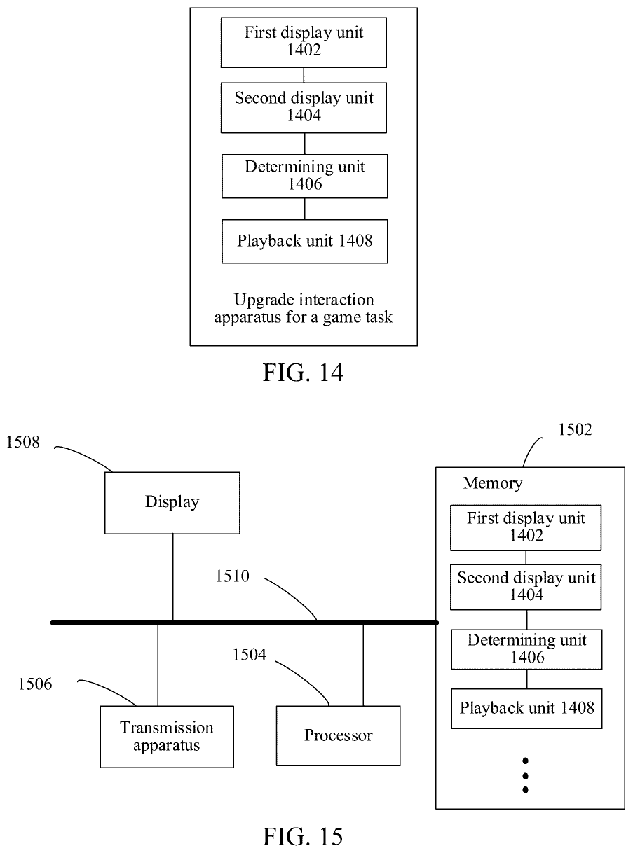

According to another aspect of aspects of the present disclosure, an upgrade interaction apparatus for a game task configured to implement the foregoing upgrade interaction method for a game task is further provided. As shown in FIG. 14, the apparatus includes:
a first display unit 1402, configured to display a task picture of a virtual game task of a controlled virtual character, the virtual game task being a multi-round confrontation task between a plurality of virtual characters, and each round of the multi-round confrontation task being a process in which two virtual characters each select at least one virtual figure to participant in a confrontation;
a second display unit 1404, configured to display a resource exchange control in the task picture, the resource exchange control being configured to obtain an upgrade resource by using a material resource owned by the controlled virtual character;
a determining unit 1406, configured to determine, in response to a control operation on the resource exchange control, an upgrade interaction state that matches an operation parameter of the control operation; and
a playback unit 1408, configured to upgrade the controlled virtual character from a first level to a second level in a case that the upgrade interaction state indicates that an upgrade acceleration condition is satisfied, and play back a corresponding upgrade animation, a quantity of virtual figures allowed to participate in a confrontation at the first level being less than a quantity of virtual figures allowed to participate in a confrontation at the second level.

In a possible implementation, the determining unit is further configured to:
obtain the operation parameter of the control operation in response to the control operation on the resource exchange control;
determine, in a case that the operation parameter satisfies an upgrade acceleration trigger condition, to trigger an upgrade acceleration mode, and obtain a resource value of a material resource currently owned by the controlled virtual character; and
determine, in a case that the resource value of the material resource currently owned by the controlled virtual character reaches a target material resource value, that the upgrade interaction state satisfies the upgrade acceleration condition, the target material resource value being determined based on a resource value of an upgrade resource that matches the second level, and the second level being adjacent to the first level.

In a possible implementation, the control operation includes a touch/press operation, and the operation parameter includes at least one of the following: touch/press duration or touch/press pressure.

In a possible implementation, the determining unit is further configured to:
determine, in a case that the touch/press duration in the operation parameter is greater than or equal to target duration, that the operation parameter satisfies the upgrade acceleration trigger condition, and determine to trigger the upgrade acceleration mode.

In a possible implementation, the determining unit is further configured to:
determine, in a case that the touch/press pressure in the operation parameter is greater than or equal to a target pressure value, that the operation parameter satisfies the upgrade acceleration trigger condition, and determine to trigger the upgrade acceleration mode.

In a possible implementation, the determining unit is further configured to:
determine, in a case that the resource value of the material resource currently owned by the controlled virtual character does not reach the target material resource value, that the upgrade interaction state does not satisfy the upgrade acceleration condition, and display prompt information configured for prompting that the controlled virtual character fails to be upgraded.

In a possible implementation, the playback unit is further configured to:
play back an upgrade buffer progress prompt animation in a case that the upgrade interaction state indicates that the upgrade acceleration condition is satisfied, the upgrade buffer progress prompt animation being configured for dynamically prompting buffer progress of upgrading the first level; and
determine, in a case that playback of the upgrade buffer progress prompt animation ends, that upgrade buffer for the first level is completed, upgrade the first level to the second level, and display prompt information indicating that the controlled virtual character is upgraded successfully.

In a possible implementation, the playback unit is further configured to:
cancel the upgrade buffer for the first level in a case that the control operation on the resource exchange control is interrupted, and maintain resource values of both a material resource and an upgrade resource owned by the controlled virtual character before the control operation.

In a possible implementation, the playback unit is further configured to play back the upgrade buffer progress prompt animation by using one of the following manners:
determining first playback duration that matches a level of the second level; and
playing back the upgrade buffer progress prompt animation based on the first playback duration; or
determining a difference between a resource value of an upgrade resource that matches the second level and a resource value of an upgrade resource currently owned by the controlled virtual character; and playing back the upgrade buffer progress prompt animation based on second playback duration that matches the difference.

In a possible implementation, the determining unit is further configured to:
determine a difference between a resource value of an upgrade resource that matches the second level and a resource value of an upgrade resource currently owned by the controlled virtual character; and
determine, in a case that a first reference resource value of an upgrade resource of the controlled virtual character is greater than or equal to the difference, that the upgrade interaction state satisfies the upgrade acceleration condition, the first reference resource value being a resource value of the upgrade resource obtained by allowing a resource value of a material resource currently owned by the controlled virtual character to be exchanged.

In a possible implementation, the playback unit is further configured to:
upgrade the controlled virtual character from the first level to the second level in a case that the upgrade interaction state indicates that the upgrade acceleration condition is satisfied, and play back an upgrade progress prompt animation, the upgrade progress prompt animation being configured for dynamically prompting upgrade progress from the first level to the second level.

In a possible implementation, the playback unit is further configured to:
determine a time interval of continuous operation duration of the control operation;
exchange material resources per unit of resource value for upgrade resources based on an exchange interval that matches the time interval, longer continuous operation duration indicating a smaller exchange interval; and
dynamically determine upgrade progress in the upgrade progress prompt animation based on an exchange result.

In a possible implementation, the playback unit is further configured to:
cancel upgrade of the first level in a case that the control operation on the resource exchange control is interrupted, update the material resource owned by the controlled virtual character to a remaining resource value at the time of the interruption, and suspend the upgrade progress prompt animation at upgrade progress reached at the time of the interruption.

In a possible implementation, the playback unit is further configured to:
continue to update, in a case that the control operation on the resource exchange control is resumed, the upgrade progress in the upgrade progress prompt animation by using the upgrade progress reached at the time of the interruption as a starting point.

In a possible implementation, the second display unit is further configured to:
prompt that the controlled virtual character is about to be upgraded to the second level, and display a remaining resource value of the material resource owned by the controlled virtual character after the upgrade.

In view of this, a task picture of a virtual game task of a controlled virtual character is displayed. The virtual game task is a multi-round confrontation task between a plurality of virtual characters. Each round of the multi-round confrontation task is a process in which two virtual characters each select at least one virtual figure to participant in a confrontation. A resource exchange control is displayed in the task picture. The resource exchange control is configured to obtain an upgrade resource by using a material resource owned by the controlled virtual character. An upgrade interaction state that matches an operation parameter of a control operation is determined in response to the control operation on the resource exchange control. The controlled virtual character is upgraded from a first level to a second level in a case that the upgrade interaction state indicates that an upgrade acceleration condition is satisfied, and a corresponding upgrade animation is played back. A quantity of virtual figures allowed to participate in a confrontation at the first level is less than a quantity of virtual figures allowed to participate in a confrontation at the second level. In this way, the upgrade interaction state corresponding to the control operation on the resource exchange control is detected to determine whether an upgrade interaction operation is completed based on a current operation, thereby avoiding a plurality of repeated operations, resolving a technical problem of poor flexibility in an existing upgrade interaction method, and achieving a technical effect of flexible upgrade based on a touch/press operation parameter.

According to another aspect of aspects of the present disclosure, an electronic device configured to implement the foregoing upgrade interaction method for a game task is further provided. The electronic device may be a terminal device or a server as shown in FIG. 15. In this aspect, an example in which the electronic device is the terminal device is used for description. As shown in FIG. 15, the electronic device includes a memory 1502 and a processor 1504. The memory 1502 has a computer program stored therein, and the processor 1504 is configured to perform operations in any of the foregoing method aspects by a computer program.

In this aspect, the electronic device may be located in at least one of a plurality of network devices in a computer network.

In this aspect, the processor may be configured to execute the computer program to perform the following operations.

S1: Display a task picture of a virtual game task of a controlled virtual character, the virtual game task being a multi-round confrontation task between a plurality of virtual characters, and each round of the multi-round confrontation task being a process in which two virtual characters each select at least one virtual figure to participant in a confrontation.

S2: Display a resource exchange control in the task picture, the resource exchange control being configured to obtain an upgrade resource by using a material resource owned by the controlled virtual character.

S3: Determine, in response to a control operation on the resource exchange control, an upgrade interaction state that matches an operation parameter of the control operation.

S4: Upgrade the controlled virtual character from a first level to a second level in a case that the upgrade interaction state indicates that an upgrade acceleration condition is satisfied, and play back a corresponding upgrade animation, a quantity of virtual figures allowed to participate in a confrontation at the first level being less than a quantity of virtual figures allowed to participate in a confrontation at the second level.

In some aspects, a person of ordinary skill in the art may understand that, a structure shown in FIG. 15 is only schematic. The electronic device may alternatively be a terminal device such as a smartphone (such as an Android mobile phone or an iOS mobile phone), a tablet computer, a palmtop computer, a mobile Internet device (MID), or a PAD. FIG. 15 does not intend to limit the structure of the foregoing electronic device. For example, the electronic device may further include more or fewer components (for example, a network interface) than those shown in FIG. 15, or has a configuration different from that shown in FIG. 15.

The memory 1502 may be configured to store a software program and a module, for example, a program instruction/module corresponding to the upgrade interaction method and apparatus for a game task in aspects of the present disclosure, and the processor 1504 performs various functional applications and data processing by running the software program and the module stored in the memory 1502, that is, implements the foregoing upgrade interaction method for a game task. The memory 1502 may be specifically, but is not limited to, configured to store information such as various elements in a scene picture, and upgrade interaction information of a game task. As an example, as shown in FIG. 15, the memory 1502 may include, but is not limited to, the first display unit 1402, the second display unit 1404, the determining unit 1406, and the playback unit 1408 in the foregoing upgrade interaction apparatus for a game task. In addition, the memory 1502 may further include, but is not limited to, another module unit in the foregoing upgrade interaction apparatus for a game task. This is not repeated in the example.

In some aspects, a transmission apparatus 1506 is configured to receive or transmit data over a network. Specific examples of the network include a wired network and a wireless network.

In addition, the electronic device further includes: a display 1508, configured to display a virtual scene in an interface; and a connection bus 1510, configured to connect each module component in the electronic device.

According to an aspect in this application, a computer program product is provided. The computer program product includes a computer program/instruction. The computer program/instruction includes program code used for performing the method shown in the flowchart. In such an aspect, the computer program may be downloaded and installed from a network through the communication part, and/or installed from the removable medium. When the computer program is executed by a central processing unit, the computer program executes functions provided in aspects of this application.

The sequence numbers of aspects of the present disclosure are merely for the description purpose but do not imply the preference among aspects.

According to an aspect of this application, a computer-readable storage medium is provided. A processor of a computer device reads a computer program from the computer-readable storage medium. The processor executes the computer program to cause the computer device to perform the foregoing upgrade interaction method for a game task.

An aspect of this application further provides a computer program product including a computer program, the computer program product, when running on a computer, causing the computer to perform the method according to the foregoing aspects.

In this aspect, a person of ordinary skill in the art may understand that all or some operations in the methods of the foregoing aspects may be performed by a program instructing hardware of the terminal device. The program may be stored in a computer-readable storage medium. The storage medium may include: a flash drive, a read-only memory (ROM), a random access memory (RAM), a magnetic disk, an optical disc, and the like.

When the integrated unit in the foregoing aspects is implemented in a form of a software functional unit and sold or used as an independent product, the integrated unit may be stored in the foregoing computer-readable storage medium. Based on such an understanding, the technical solutions of the present disclosure essentially, or the part contributing to related art, or all or some of the technical solutions may be presented in the form of a software product. The computer software product is stored in the storage medium, and includes several instructions for instructing one or more computer devices (which may be a personal computer, a server, a network device, or the like) to perform all or some of the operations of the foregoing methods described in aspects of the present disclosure.

In the foregoing aspects of the present disclosure, the descriptions of aspects have different focuses. For a part that is not detailed in an aspect, reference may be made to the relevant description of other aspects.

In the several aspects provided in this application, the disclosed client may be implemented in another manner. The apparatus aspect described above is merely exemplary. For example, the unit division is merely logical function division and may be other division in actual implementation. For example, multiple units or components may be combined or integrated into another system, or some features may be omitted or not performed. In addition, the coupling, or direct coupling, or communication connection between the displayed or discussed components may be the indirect coupling or communication connection through some interfaces, units, or modules, and may be electrical or of other forms.

The units described as separate components may or may not be physically separate, and components displayed as units may or may not be physical units, and may be located in one position or may be distributed on a plurality of network units. Some or all of the units may be selected based on actual requirements to achieve the objectives of the solutions of aspects.

In addition, functional units in aspects of the present disclosure may be integrated into one processing unit, or each of the units may be physically separated, or two or more units may be integrated into one unit. The integrated unit may be implemented in the form of hardware, or may be implemented in a form of a software functional unit.

The foregoing descriptions are exemplary implementations of the present disclosure. A person of ordinary skill in the art may make some improvements and modifications without departing from the principle of the present disclosure and the improvements and modifications shall fall within the protection scope of the present disclosure.

What is claimed is:

1. A computer assisted method comprising:
executing a virtual game task comprising a multi-round confrontation between a plurality of virtual characters, wherein each round of the multi-round confrontation task includes a process in which two virtual characters each select at least one virtual figure to participate in a confrontation, and wherein at least one of the two virtual characters is a player controlled character;
receiving first user input via a resource exchange control of a graphical user interface of the virtual game task, wherein the resource exchange control is usable to upgrade a first virtual figure by consuming a material resource owned by the controlled virtual character;
determining an upgrade speed based in part on a comparison of the received first user input with an upgrade acceleration condition; and
upgrading the controlled virtual character from a first level to a second level when the determined upgrade speed is an accelerated upgrade speed, and playing back a corresponding upgrade animation, a quantity of virtual figures allowed to participate in a confrontation at the first level being less than a quantity of virtual figures allowed to participate in a confrontation at the second level.

2. The method according to claim 1, wherein the determining the upgrade speed comprises:
determining, when the determined upgrade speed is an accelerated upgrade speed, a resource value of the material resource currently owned by the controlled virtual character; and
determining, when the value of the material resource currently owned by the controlled virtual character reaches a target material resource value based on the second level, the upgrade speed to be the accelerated upgrade speed, and the second level being adjacent to the first level.

3. The method according to claim 2, wherein the first user input comprises a touch/press operation, and the operation parameter comprises at least one of the following: touch/press duration or touch/press pressure.

4. The method according to claim 3, wherein after the obtaining the operation parameter of the first user input, the method further comprises:
determining, when the touch/press duration in the operation parameter is greater than or equal to a target duration, that the operation parameter satisfies the upgrade acceleration trigger condition, and determining to trigger the upgrade acceleration mode.

5. The method according to claim 3, wherein after the obtaining the operation parameter of the first user input, the method further comprises:
determining, when the touch/press pressure in the operation parameter is greater than or equal to a target pressure value, that the operation parameter satisfies the upgrade acceleration trigger condition, and determining to trigger the upgrade acceleration mode.

6. The method according to claim 2, wherein after the obtaining a value of a material resource currently owned by the controlled virtual character, the method further comprises:
determining, when the value of the material resource currently owned by the controlled virtual character does not reach the target material resource value, that the upgrade interaction state does not satisfy the upgrade acceleration condition, and displaying information configured for prompting that the controlled virtual character fails to be upgraded.

7. The method according to claim 1, wherein the upgrading the controlled virtual character from a first level to a second level comprises:
playing back an upgrade buffer progress prompt animation when the upgrade interaction state indicates that the upgrade acceleration condition is satisfied, the upgrade buffer progress prompt animation being configured for dynamically prompting buffer progress of upgrading the first level; and
determining, when playback of the upgrade buffer progress prompt animation ends, that upgrade buffer for the first level is completed, upgrading the first level to the second level, and displaying prompt information indicating that the controlled virtual character is upgraded successfully.

8. The method according to claim 7, wherein during the playing back the upgrade buffer progress prompt animation, the method further comprises:
canceling the upgrade buffer for the first level when the control operation on the resource exchange control is interrupted, and maintaining resource values of both the material resource and an upgrade resource owned by the controlled virtual character before the control operation.

9. The method according to claim 7, wherein the playing back the upgrade buffer progress prompt animation comprises only one of the following:
determining first playback duration that matches a level of the second level; and playing back the upgrade buffer progress prompt animation based on the first playback duration; or
determining a difference between a resource value of an upgrade resource that matches the second level and a resource value of an upgrade resource currently owned by the controlled virtual character; and playing back the upgrade buffer progress prompt animation based on second playback duration that matches the difference.

10. The method according to claim 7, wherein after the determining the upgrade speed, the method further comprises:
determining a difference between a resource value of an upgrade resource that matches the second level and a resource value of an upgrade resource currently owned by the controlled virtual character; and
determining, when a first reference resource value of an upgrade resource of the controlled virtual character is greater than or equal to the difference, that the upgrade interaction state satisfies the upgrade acceleration condition, the first reference resource value being a resource value of the upgrade resource obtained by allowing a resource value of a material resource currently owned by the controlled virtual character to be exchanged.

11. The method according to claim 1, wherein the upgrade progress prompt animation is configured for dynamically prompting upgrade progress from the first level to the second level.

12. The method according to claim 11, wherein the playing back the upgrade progress prompt animation comprises:
determining a time interval of continuous operation duration of the control operation;
exchanging material resources per unit of resource value for upgrade resources based on an exchange interval that matches the time interval, longer continuous operation duration indicating a smaller exchange interval; and
dynamically determining upgrade progress in the upgrade progress prompt animation based on an exchange result.

13. The method according to claim 12, wherein during the playing back an upgrade progress prompt animation, the method further comprises:
canceling upgrade of the first level when the control operation on the resource exchange control is interrupted, updating the material resource owned by the controlled virtual character to a remaining resource value at the time of the interruption, and suspending the upgrade progress prompt animation at upgrade progress reached at the time of the interruption.

14. The method according to claim 13, wherein after the canceling upgrade of the first level, the method further comprises:
continuing to update, when the control operation on the resource exchange control is resumed, the upgrade progress in the upgrade progress prompt animation by using the upgrade progress reached at the time of the interruption as a starting point.

15. The method according to claim 1, wherein during the playing back the corresponding upgrade animation, the method further comprises:
prompting that the controlled virtual character is about to be upgraded to the second level, and displaying a remaining resource value of the material resource owned by the controlled virtual character after the upgrade.

16. One or more non-transitory computer readable media storing computer readable instructions which, when executed by a processor, configure a data processing system to perform:
executing a virtual game task comprising a multi-round confrontation between a plurality of virtual characters, wherein each round of the multi-round confrontation task includes a process in which two virtual characters each select at least one virtual figure to participate in a confrontation, and wherein at least one of the two virtual characters is a player-controlled character;
receiving first user input via a resource exchange control of a graphical user interface of the virtual game task, wherein the resource exchange control is usable to upgrade a first virtual figure by consuming a material resource owned by the controlled virtual character;
determining an upgrade speed based in part on the material resource and a comparison of the received first user input with an upgrade acceleration condition; and
upgrading the controlled virtual character from a first level to a second level when the determined upgrade speed is an accelerated upgrade speed, and playing back a corresponding upgrade animation, a quantity of virtual figures allowed to participate in a confrontation at the first level being less than a quantity of virtual figures allowed to participate in a confrontation at the second level.

17. The computer readable media of claim 16, determining an upgrade speed comprises:
determining the upgrade speed to be an accelerated upgrade speed responsive to determining first user input to be a long press gesture, and the material resource owned by the controlled virtual character being sufficient to upgrade to a next level; and
determining the upgrade speed to be a regular upgrade speed responsive to determining first user input to be a short press gesture, and the material resource owned by the controlled virtual character being sufficient to upgrade by a predefined increment.

18. The computer readable media of claim 17, further comprising:
repeating the upgrading the controlled virtual character by additional levels while the first user input is maintained, and while the material resource continues to be sufficient for upgrading the each additional level.

19. A system comprising:
a processor; and
memory storing computer readable instructions which, when executed by the processor, configure the system to perform:
executing a virtual game task comprising a multi-round confrontation between a plurality of virtual characters, wherein each round of the multi-round confrontation task includes a process in which two virtual characters each select at least one virtual figure to participate in a confrontation, and wherein at least one of the two virtual characters is a player-controlled character;
receiving first user input via a resource exchange control of a graphical user interface of the virtual game task, wherein the resource exchange control is usable to upgrade a first virtual figure by consuming a material resource owned by the controlled virtual character;
determining an upgrade speed based in part on the material resource and a comparison of the received first user input with an upgrade acceleration condition; and
upgrading the controlled virtual character from a first level to a second level when the determined upgrade speed is an accelerated upgrade speed, and playing back a corresponding upgrade animation, a quantity of virtual figures allowed to participate in a confrontation at the first level being less than a quantity of virtual figures allowed to participate in a confrontation at the second level.

20. The system of claim 19, wherein determining the upgrade speed comprises:
determining the upgrade speed to be an accelerated upgrade speed responsive to determining first user input to be a long press gesture, and the material resource owned by the controlled virtual character being sufficient to upgrade to a next level; and
determining the upgrade speed to be a regular upgrade speed responsive to determining first user input to be a short press gesture, and the material resource owned by the controlled virtual character being sufficient to upgrade by a predefined increment.
